(19) United States
(12) Patent Application Publication
(10) Pub. No.: US 2008/0164998 A1
(43) Pub. Date: Jul. 10, 2008

(54) Location Sensitive Healthcare Task Management System

(75) Inventors: Harm Jacob Scherpbier, Fort Washington, PA (US); Jonathan D. Emanuele, Phoenixville, PA (US); Jonathan W. Trigg, Chadds Ford, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL SOLUTIONS USA, INC., MALVERN, PA (US)

(21) Appl. No.: 11/960,835

(22) Filed: Dec. 20, 2007

Related U.S. Application Data
(60) Provisional application No. 60/883,554, filed on Jan. 5, 2007.
(60) Provisional application No. 60/914,080, filed on Apr. 26, 2007.

(51) Int. Cl. H04Q 7/00

(52) U.S. Cl. 340/539.13

(57) ABSTRACT

A Workflow Management System is integrated with a Healthcare Information System and uses location tracking of patients, providers and resources in addition to relevant patient data in managing tasks of clinicians associated with care of a patient. A personnel and device location sensitive system for managing healthcare worker tasks includes a tracking processor. The tracking processor monitors healthcare worker, patient and equipment location, to provide device and personnel location data by detection of wirelessly communicating tag devices attached to healthcare workers, patients and equipment. A display processor uses the location data for initiating generation of data representing at least one display image associating a work task, comprising providing a treatment related service to a patient, for performance by a healthcare worker, with a current location of a patient and equipment to be used in providing the treatment related service. A workflow engine uses the location data for updating a task list of a healthcare worker to indicate tasks ranked in response to a plurality of different factors including one or more of, (a) task urgency, (b) location of particular equipment used in a particular task and (c) worker skill level.

This is a non-provisional application of provisional application Ser. No. 60/883,554 filed Jan. 5, 2007, by J. D. Emanuele et al. and of application Ser. No. 60/914,080 filed Apr. 26, 2007, by J. D. Emanuele et al.

### FIELD OF THE INVENTION

This invention concerns a personnel and device location sensitive system for managing healthcare worker tasks, involving monitoring healthcare worker, patient and equipment location.

### BACKGROUND OF THE INVENTION

In the diagnosis and treatment of a patient, a series of steps are performed by a healthcare team comprising a process of care delivery. The goal of Workflow Management in Healthcare is to provide care with the highest quality, ensuring patient safety, in the most efficient way realizable. Hospitals and other healthcare provider organizations, such as clinics, use Workflow Management technology to automate processes for providing healthcare to as many patients as possible, with the least amount of staffing and equipment.

Known workflow management systems fail to comprehensively accommodate and integrate location information indicating geographic location or nearness to a patient. In known systems, the location of patients, workers and equipment is typically not known to an information system, which therefore does not take this information into account when deciding which tasks to assign to whom, and in what order. Therefore, one healthcare team may have work tasks scheduled that are for patients on different floors, or in faraway locations resulting in wasting time moving back and forth. Further, tasks are assigned for patients who are not in their rooms, but in other departments for other diagnostic or therapeutic procedures. As a result, in known systems, a healthcare worker may show up to a patient room in to perform an activity and find the patient not there. A healthcare team may also have to move to a work location that is actually closer to a different team. Location or nearness is not comprehensively considered for task allocation and work distribution in known systems. Workers may try to locate an available EKG cart, which may be in use by another team, for example. A system according to invention principles addresses these deficiencies and related problems.

### SUMMARY OF THE INVENTION

A Workflow Management System optimizes processes by assigning work to the right person at the right time. For individual tasks, a workflow management system decides who to assign the work to by identifying a person in the correct role (job function), who has the least amount of workload, and who is geographically near the patient. A system uses location tracking of patients, providers and resources in combination with a Workflow Management System to optimize processes by minimizing unnecessary movements. A personnel and device location sensitive system for managing healthcare worker tasks includes a tracking processor. The tracking processor monitors healthcare worker, patient and equipment location, to provide device and personnel location data by detection of wirelessly communicating tag devices attached to healthcare workers, patients and equipment. A display processor uses the location data for initiating generation of data representing at least one display image associating a work task, comprising providing a treatment related service to a patient, for performance by a healthcare worker, with a current location of a patient and equipment to be used in providing the treatment related service. A workflow engine uses the location data for updating a task list of a healthcare worker to indicate tasks ranked in response to a plurality of different factors including one or more of, (a) task urgency, (b) location of particular equipment used in a particular task and (c) worker skill level.

### BRIEF DESCRIPTION OF THE DRAWING

FIG. 1 shows a personnel and device location sensitive system for managing healthcare worker tasks, according to invention principles.

FIG. 2 illustrates a wireless personnel and device location tracking system, according to invention principles.

FIG. 3 shows a user interface image navigation structure employed by a personnel and device location sensitive system for managing healthcare worker tasks, according to invention principles.

FIG. 4 shows a user interface display image illustrating addition of tasks to a healthcare worker task in response to wireless data communication, according to invention principles.

FIG. 5 shows a flowchart of a process for load balancing task allocation performed by a personnel and device location sensitive system for managing healthcare worker tasks, according to invention principles.

FIG. 6 shows a flowchart of a process performed by a personnel and device location sensitive system for managing healthcare worker tasks, according to invention principles.

### DETAILED DESCRIPTION OF THE INVENTION

A personnel and device location sensitive system for managing healthcare worker tasks employs a Workflow Engine in a healthcare setting to allocate tasks to worker teams not only based on their existing workload, but also based on their location in a building, and their nearness to a patient or to necessary equipment. The system avoids unnecessary movement of workers, patients, and resources by taking location and nearness into account in task load balancing. The workflow engine employs data indicators indicating workload, and nearness to a patient, for example, in assigning tasks to workers.

The system supports both Healthcare organization personnel and device mobility. This includes the mobility of, patients (e.g., moving to a CT-scanner, or an operating room), healthcare providers (e.g., doctors, nurses and therapists visiting a patient), and resources (ultrasound machines, ECG machines, wheeled through a hospital to be used in the process of patient care). The system optimizes process efficiency by minimizing movement. Specifically, the system monitors location of patients, providers and resources and uses a Workflow Management System to optimize processes by minimizing unnecessary movements. The Workflow Management System is integrated with a Healthcare Information System, tracking relevant patient data and providing access to patient data by clinicians associated with care of a patient. The Workflow Management System allows healthcare organizations to define processes, which are automated and executed by the Workflow Management System. Processes include the steps that need to be performed to complete a process, and resources required for an individual step. The Workflow Management System allocates tasks to healthcare personnel, based on a process definition.

Radio-Frequency Identification (RFID) tags are affixed to healthcare personnel, to patients in healthcare provider facilities and to resources used in a process of healthcare. RFID detector devices are placed at critical locations in a building in order to track the location of RFID-tagged patients, healthcare workers and resources. Other location detection systems may also be used including Bluetooth, GPS and Ultrasound systems, for example, involving affixing tag or receiver devices to healthcare personnel, patients and resources. The system links the locations of healthcare workers, patients and resources to processes tracked by a workflow engine and uses the location-information to optimize workflow processing, to allocate tasks to certain healthcare workers, to prioritize and re-prioritize sequences of tasks, and to initiate, terminate or modify processes.

An executable application, as used herein, comprises code or machine readable instructions for conditioning a processor to implement predetermined functions, such as those of an operating system, a context acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A user interface (UI), as used herein, comprises one or more display images, generated by a display processor and enabling user interaction with a processor or other device and associated data acquisition and processing functions. The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application manipulates the UI display images in response to the signals received from the input devices. In this way, the user interacts with the display image using the input devices, enabling user interaction with the processor or other device. The functions and process steps herein may be performed automatically or wholly or partially in response to user command. An activity (including a step) performed automatically is performed in response to executable instruction or device operation without user direct initiation of the activity. Workflow comprises a sequence of tasks performed by a device or worker or both. An object or data object comprises a grouping of data, executable instructions or a combination of both or an executable procedure.

A workflow processor, as used herein, processes data to determine tasks to add to a task list, to remove from a task list or modifies tasks incorporated on, or for incorporation on, a task list. A task list is a list of tasks for performance by a worker or device or a combination of both. A workflow processor may or may not employ a workflow engine. A workflow engine, as used herein, is a processor executing in response to predetermined process definitions that implement processes responsive to events and event associated data. The workflow engine implements processes in sequence and/or concurrently, responsive to event associated data to determine tasks for performance by a device and or worker and for updating task lists of a device and a worker to include determined tasks. A process definition is definable by a user and comprises a sequence of process steps including one or more, of start, wait, decision and task allocation steps for performance by a device and or worker, for example. An event is an occurrence affecting operation of a process implemented using a process definition.

A Workflow Management System (business process management) is a software system using a workflow engine that manages processes. It includes a process definition function that allows users to define a process that should be followed, an Event Monitor, which captures events from a Healthcare Information System and communicates the results to the Workflow Management System. A processor in the Management System tracks which processes are running, for which patients, and what step needs to be executed next, according to a process definition. The Management System includes a procedure for notifying clinicians of a task to be performed, through their worklists and a procedure for allocating and assigning tasks to specific users or specific teams. A document or record comprises a compilation of data in electronic form and is the equivalent of a paper document and may comprise a single, self-contained unit of information.

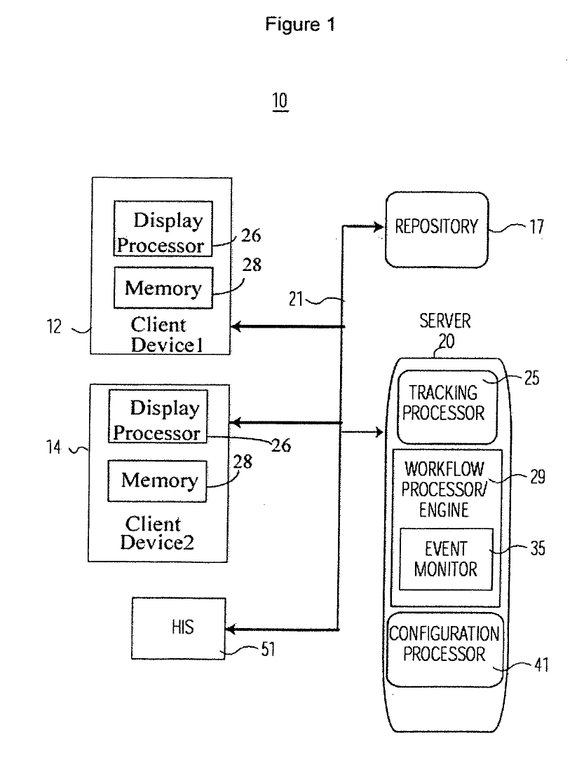

FIG. 1 shows personnel and device location sensitive system 10 for managing healthcare worker tasks, including client devices (workstations) 12 and 14, repository 17, hospital information system (HIS) 51 and server 20 inter-communicating via network 21. HIS 51 is a software system that captures and stores patient clinical data and provides access to clinical information to workers (e.g., physicians and nurses) in a healthcare provider organization. HIS 51 allows a physician to place orders for tests, medications, procedures and treatments to be administered to a patient and presents forms to users by which they enter documentation for the patient and captures and stores clinical documentation. A worklist is provided for individual healthcare workers, showing tasks the individual workers are scheduled to perform, for which patients and at what time. Tasks are ranked according to relative priority so a worker knows which work items have the highest urgency.

Workstations (client devices) 12 and 14 individually include memory 28 and a display processor 26. Display processor 26 provides data representing display images for presentation on workstation 12 and 14. Repository 17 includes worker information identifying healthcare workers for performing tasks as well as worker associated communication data for use in informing healthcare workers of tasks to be performed. Repository 17 also includes data identifying workers, rooms and equipment (and their locations) that links the locations of healthcare workers, patients and resources to processes tracked by a workflow engine as well as events in a hospital information system.

Personnel and device location sensitive system 10 manages healthcare worker tasks, using tracking processor 25 for monitoring healthcare worker, patient and equipment location to provide device and personnel location data by detection of wirelessly communicating (e.g., RFID) tag devices attached to healthcare workers, patients and equipment. The system combines RFID location tracking with workflow task management using a workflow processor and workflow engine. The workflow engine takes into account worker, patient and equipment location, before assigning a task using location information derived from RFID attached tags to patients, workers and resources. RFID tracking of patients, workers and resources enables location/nearness data to be used by a workflow engine for process optimization.

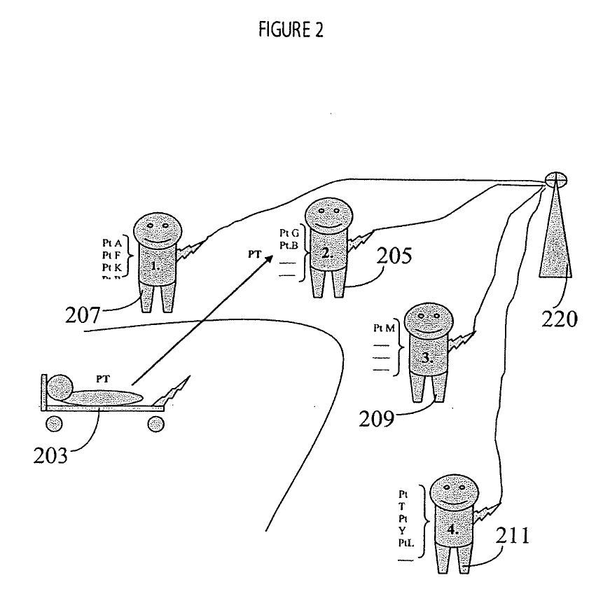

FIG. 2 illustrates a wireless personnel and device location tracking system. One or more detectors 220 detect RFID tags attached to workers (e.g. in a badge), patients (e.g. a wristband) and resources (e.g., equipment) and provides location information (e.g., locations 203, 205, 207, 209, 211) to tracking processor 25 (FIG. 1). The system integrates location tracking using REID (or alternatively, using GPS, Infrared, Bluetooth, cell phone, mobile processing device tracking etc.) for tracking patients, workers, and resources in a healthcare setting. This allows location and nearness to be included as factors in healthcare workers decision making and task completion. System 10 (FIG. 1) is advantageously aware of a relationship of a task, assigned by workflow processor 29 (including a workflow engine) to a specific user and associates the task with a location of patient, worker and resources. Detectors are located at strategic locations in a building allowing tags to be located. Tags (and their identifiers) are mapped/linked to a patient, a worker, or a piece of equipment in a look-up table, for example, stored in repository 17. Similarly, a map links detector locations with physical locations allowing workflow processor 29 to know where patients, workers and resources are located. Thereby, tracking processor 25 detects a patient has moved from location 203 to location 205. Radio Frequency Identification (RFID) employs tags that are attached to patients, care providers, and equipment, which can be read by detectors throughout a facility, which detect the location of a tag. Two main categories are “passive” and “active” RFID. In “passive” RFID, the tag is small and does not transmit, and needs to be very close to a detector to be detected. In this case, a few detectors are positioned at key points in the facility, and the tag is only detected if it passes the detector. In “active” RFID, the tags transmit their identity continuously to detectors in multiple locations, which allows constant tracking of individual tag location. System 10 is applicable to both (and other) forms of RFID.

Display processor 26 uses the location data for initiating generation of data representing at least one display image associating a work task, comprising providing a treatment related service to a patient, for performance by a healthcare worker, with a current location of a patient and equipment to be used in providing the treatment related service. Workflow processor 29 uses the location data for updating a task list of a healthcare worker to indicate tasks ranked in response to multiple different factors including, task urgency, location of particular equipment used in a particular task, worker skill level and role, location of patient to whom a task pertains and location of a worker to whom the task will be assigned. The worker skill level includes worker experience level and worker skill level in operating the particular equipment used in the particular task.

A workflow engine in processor 29 uses the location data for updating a task list of a healthcare worker to indicate tasks ranked in response to, current workload of the healthcare worker, a location of a patient to whom the tasks pertain, a role of the healthcare worker, a location of the healthcare worker, a location for performance of a particular task and nearness of the location of the particular equipment to the location for performance of the particular task and nearness of the location of a patient and location of a healthcare worker to the location for performance. The workflow engine balances workload of a healthcare worker in response to a process definition. Also, the workflow engine balances the workload of the healthcare worker in response to, current workload and role of the worker and task urgency, worker and equipment location, worker and patient location and location of performance of a task. Configuration processor 41 is employed by a user to establish, modify and configure process definitions and other tracking processor 25 and workflow processor 29 characteristics.

Workflow processor 29 executes in response to predetermined process definitions to determine tasks to add to a worker task list and manage processes responsive to events occurring in HIS 51. Workflow processor 29 includes event monitor 35 for identifying the events, using data from Hospital Information System 51. Workflow processor 29 tracks different concurrent task processes for corresponding different patients and steps to be executed next in response to a process definition. A process is a series of steps, executed by one or more workers (in a healthcare team) and/or devices, over a period of time, to achieve an objective. Examples of processes in a healthcare setting: admitting a patient with heart failure, ordering and performing a CT scan, discharging a patient to a nursing home, cleaning a room and bed after patient discharge. In a healthcare setting, workflow processor 29 allocates tasks to teams not only based on their existing workload, but also based on their location in a building, and their nearness to the patient or to necessary equipment and also based on a load balancing determination. Workflow processor 29 accommodates data indicators of workload, and nearness, in assigning tasks to workers and task load balancing and reduces unnecessary movement of workers, patients and resources.

Workflow processor 29 manages a process by assigning work to workers in response to a definition of a process. For example, for a “discharge patient” process, some of the tasks allocated to the healthcare workers include: write a discharge note (assigned to a physician), complete discharge assessment (assigned to a nurse), transport a patient to a hospital exit (assigned to a transportation orderly), etc. Allocation of tasks is based on the role of a worker and may take into account how many other tasks the worker already has.

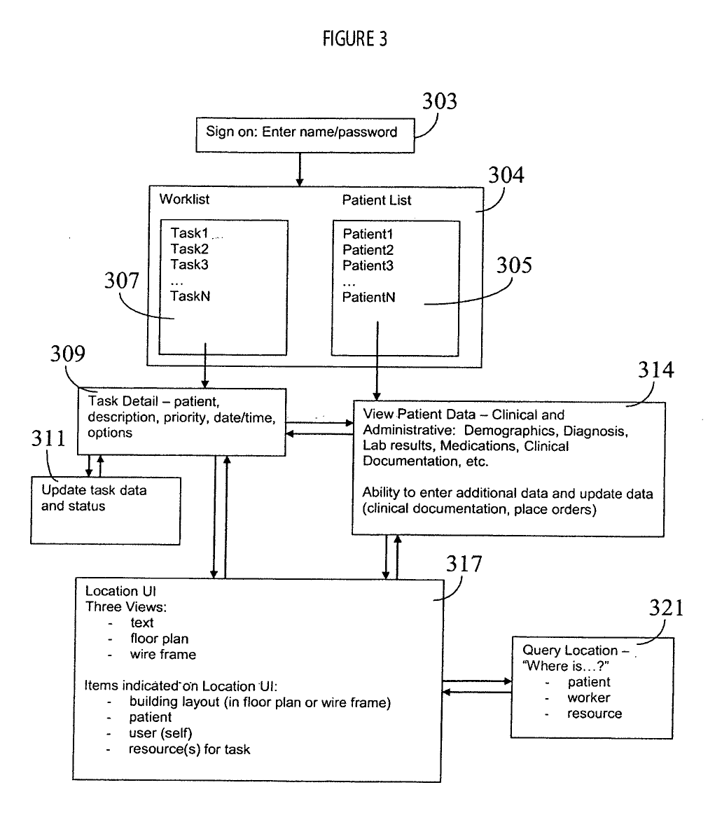

FIG. 3 shows a user interface image navigation structure involving images provided by display processor 26 and displayed on workstation 12 employed by personnel and device location sensitive system 10 for managing healthcare worker tasks. The image navigation structure illustrates use of location information in load balancing and optimizing a process. In response to healthcare worker entry of a userid and password via a displayed image window element 303, composite image window 304 is displayed including a task list of the worker 307 and associated patients in patient list 305. The worker is able to initiate generation of an image window 309 identifying characteristics of individual tasks selected in window 307. Window 309 identifies a patient and indicates a task description, priority, time and date, location for task performance and options associated with an individual selected task. A worker is able to update task and status data in display element 311. Image window 317 is displayed in response to worker selection of an element associated with a location of a task indicated in window 309. Window 317 indicates individual task associated location data in text, on a building floor plan or in a 3D representation of a building (e.g., a wire frame representation), for example. The location shows a building layout, a patient location, the location of the worker and resources needed for the individual task. For a particular task, image window 317 shows, location of a patient in text format (for example, room 321, or Radiology), the location of a patient, user and other resources superimposed on a floor plan or location of a patient, user and other resources superimposed on a wire frame 3D building representation. Further task location related data is displayed in image display element 321 in response to a query of the worker, e.g., involving patient, worker and location associated with task performance.

Tracking processor 25 (FIG. 1) maintains location information for tagged patients, workers and resources in repository 17. When a user selects a particular task in window 307 and initiates display of image window 309 providing data concerning the particular task, window 309 indicates a location of the patient (based on the most up to date, last detected location of the patient's tag), a location of the worker (also based on last reading of worker's tag), and any resources that may be required for this task. Configuration processor 41 enables incorporation of hospital buildings and facilities and floor plans and wire frames, in image window 309. Thereby, a user is able to navigate window 309 by selecting different floors, other units and other buildings through interaction with window 309 and selecting respective locations. RFD locations are mapped to floor plans and wire frames, using configuration processor 41 enabling tracking processor 25 to correlate and visualize a last tag reading with a location on the map and wire frame.

A worker is able to initiate generation of image window 314 identifying characteristics of individual patients selected in window 305. Specifically, window 314 indicates clinical and administrative data and an associated worker selectable location element and task identifier. The clinical and administrative data of an individual patient includes demographic information (age, gender, height, weight, pregnancy etc.), diagnosis, laboratory test results and medication data as well as clinical documentation, for example. Window 314 enables a worker to enter additional data and update data such as clinical documentation and enables a user to initiate placing of orders for treatment to be administered to a patient. Image window 317 is displayed in response to worker selection of an element associated with a location of a patient indicated in window 314. A worker is able to navigate between patient and task windows 314 and 309 respectively by selection of task identifier and patient identifier in respective windows.

In an illustration of system 10 (FIG. 1) operation, a patient is discharged from room 321 and the room needs to be cleaned. Workflow processor 29 needs to assign the task “clean room 321” to a housekeeping crew. Using RFID tags, tracking processor 25 detects and monitors where the 7 housekeeping crews are in a hospital. Crew A is in a hallway close to room 321 but has 2 other rooms to clean in the same hallway. Crew B is on the same floor, but in a different wing and has no current rooms to clean. Using decision logic in a process definition, a workflow engine in processor 29 assigns the task “clean room 321” to crew B. This task appears in worklist 307 (FIG. 3) of crew B presented in display image 304 provided by display processor 26 on workstation 12 or alternatively on a mobile processing device display. In another illustration of system 10 operation, a respiratory therapist is treating patients in the hospital. The workflow engine optimizes the worklist for the respiratory therapist, in order to treat as many patients as possible in the least amount of time. The therapist is finished with a patient and marks the treatment as “complete”. Before assigning the next patient, the workflow engine tracks the location of the next patient, and sees that the patient is not in his room, but in a radiology department for an X-ray. Therefore, the workflow engine communicates a message to the respiratory therapist (e.g., by voice mail, email or via a worklist) informing the therapist to skip that patient for now and to proceed with the next patient on the list.

System 10 provides appointment times for treatment activities based on wireless device reminders and RFID data and manages workflow based on where things are located and other factors. System 10 identifies work that a worker needs to perform in an optimized order, (determined based on task priority, spatial locations and other factors). The system advantageously combines RFID with Workflow Management to provide location-based workflow optimization and load balancing. In an example of operation, at 9:30 AM an orthopedic surgeon examines a patient who has had knee joint replacement surgery. The orthopedic surgeon plans to discharge the patient from a hospital as a routine discharge to occur at 11 AM. During the examination, the patient speaks of pain in the right calf that happened walking from the bed to the bathroom and upon examination physician notices mild swelling of the calf/ankle area. The orthopedic surgeon delays the discharge order, and orders a portable ultrasound to rule out deep vein thrombosis (DVT). The Tasks and resources required for this order include a portable ultrasound machine and an Ultra-sound (US) technician skilled in DVT examinations. The tasks involve a physician, at the patient's bedside, placing an order for an Ultrasound, with the condition that it be completed by 10:30 am in order to facilitate on-time discharge. In response to a process definition for Ultrasound Orders as implemented by a Workflow Engine in processor 29, the workflow engine allocates the task to an ultrasound team with an appropriate skill level and that is best able to complete the procedure by 10:30 am.

Tracking processor 25 determines RFID sensors have located five mobile US units assigned to technicians with various skill levels as shown in Table I.

TABLE I
Equipment Status
Ultra Sound Systems Status (as of 9:31 AM 12/18/2006)

| US | | When | Tech/Skill | | | | |
|---|---|---|---|---|---|---|---|
| Ma- | | Avail? | 1 = most | Pavil- | | | |
| chine | Status | minutes | 4 = least | ion | Flr/Rm | Bed | Patient |
| 6001 | Active | 25 | JTM/1 | B | 3-353 | 2 | HJS |
| 6002 | Active | 10 | TBC/2 | B | 2-217 | 1 | RJM |
| 6003 | Active | 10 | STM/3 | B | 8-812 | 2 | JMM |
| 6004 | Active | 20 | RCR/4 | B | 8-828 | 2 | APS |
| 6005 | Maint | — | — | B | B-006 | — | — |

An RFID badge of a US technician contains an identifier that indicates skill level and experience concerning multiple diseases commonly diagnosed using the US system. Workflow processor 29 evaluates the different US technicians capabilities and attributes and the location of equipment by comparing the technician and equipment present geographic location relative to a patient room. Workflow processor 29 calculates the time to move the equipment from a present location to the location of the placed order and automatically assigns the order to the most suitable combination of location and technician skill level conforming to constraints and requirements of the placed order. If workflow processor 29 determines there is a time conflict because the portable ultrasound machine had been previously assigned for use to fulfill a second order, the second order is reassigned to the next best combination of machine and technician. The method is iterative until open orders are assigned so that a US technician receives a signal indicating the location of a next procedure. In this example, workflow processor 29 automatically chooses operator JTM/1 though less experienced with this US procedure because the US technician is available and closest geographically to the patient as indicated in Table II.

TABLE II
Technician status

| | | | | Patient | Exam | Used | Estimated |
|---|---|---|---|---|---|---|---|
| | Avail | Transport | Setup | Movement | Time | No. of | completion |
| 9:30 | minutes | minutes | minutes | time | minutes | times | time |
| 6001/JTM/1 | 0 | 4 | 5 | 3 | 16 | 28 | 9:58 |
| 6002/TBC/2 | 10 | 6 | 5 | 3 | 12 | 36 | 10:06 |
| 6003/STM/3 | 10 | 8 | 5 | 3 | 10 | 36 | 10:06 |
| 6004/RCR/4 | 20 | 8 | 5 | 3 | 8 | 44 | 10:24 |

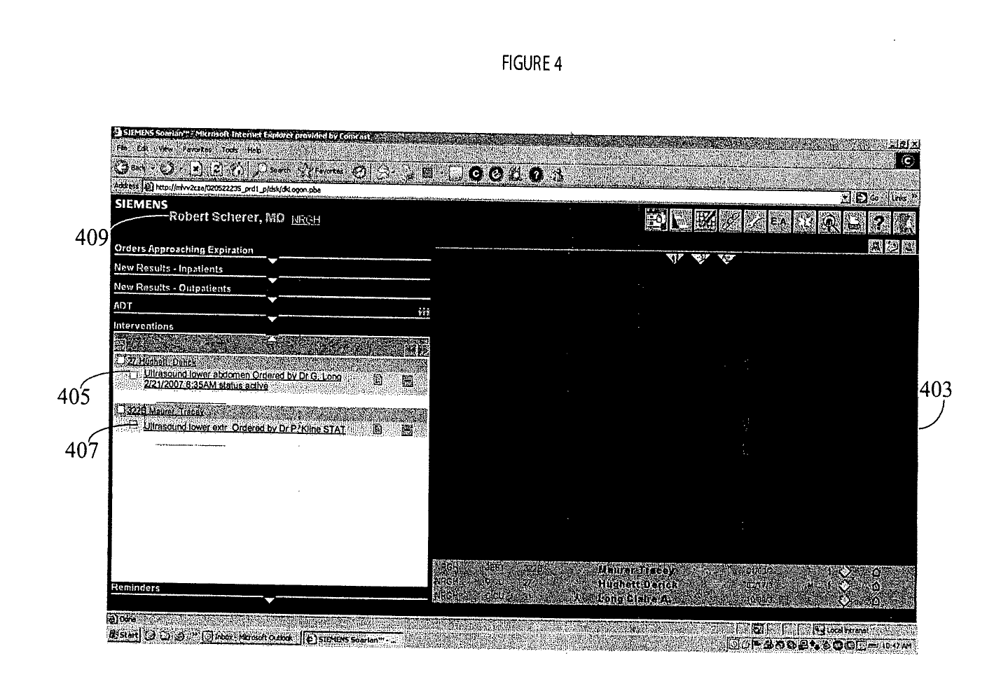

Workflow processor 29 automatically reassigns a next series of US examinations using the same method and in accordance with US examination urgency indicators. Individual US technicians are notified of a next assignment using mobile communications devices such as a secure PDA (Personal Digital Assistant) or a secure laptop computer. FIG. 4 shows user interface display image 403 illustrating addition of tasks 405 and 407 to a healthcare worker task in response to wireless data communication. Specifically, task 405 indicates an ultrasound examination is to be performed on a first patient and task 407 indicates an emergency ultrasound examination is to be performed on a second patient by a physician (R. Scherer 409).

Workflow processor 29 is responsive to movement from one location to another, by patient, staff member or equipment, indicated in event messages. Processor 29 responds to event messages either by initiating a new process, or by terminating a process, or by moving to a next step in a process. In a patient discharge management workflow, for example, when a patient leaves a room and leaves a building the discharge management workflow is terminated. In a surgery preparation workflow, when a patient arrives in an operation room (OR) preparation area, processor 29 initiates pre-operative checks prior to surgery, such as administering pre-operative prophylactic antibiotics.

Workflow processor 29 uses location data of patient, staff or equipment as decision criteria in a process, at a point where various next steps are possible, and the process determines which path to take based on patient location. If a nurse, for example, records that a patient smokes, a clinical guideline workflow initiates smoking cessation counseling for the patient. Workflow processor 29 also accommodates exceptions associated with patient location. If patient location is a delivery room, or critical care unit, or Emergency department (ED), for example, smoking cessation counseling is not initiated, but rather a wait of 24 hours is performed followed by another wait period and a check to determine if the patient is in a standard care unit and initiation of smoking cessation counseling. In a dietary workflow processor 29 communicates data indicating a task to a kitchen involving delivering meal trays to a different floor if a patient has been transferred, but only if a nurse or care unit secretary processes the transfer. Workflow processor 29 manages tray delivery based on patient location using a workflow that verifies where a patient is, before a kitchen worker places a meal tray in a transportation cart.

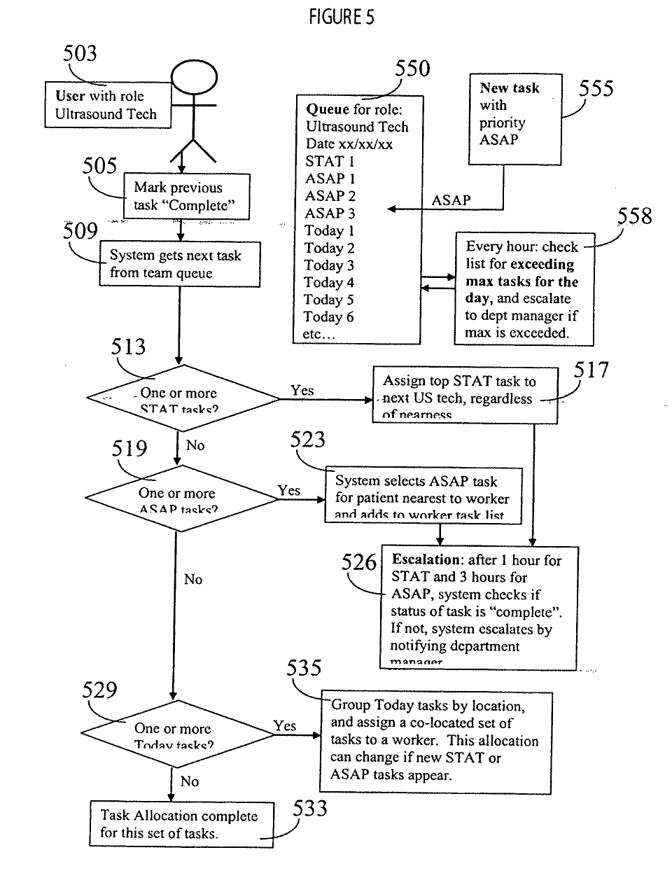

FIG. 5 shows a flowchart of a process for load balancing task allocation performed by personnel and device location sensitive system 10 (FIG. 1) for managing healthcare worker tasks. A worker 503 occupying the role of an ultrasound imaging technician updates his worklist (a tasklist) in step 505 to indicate a previous task is complete. Workflow processor 29 acquires data indicating one or more next tasks from a healthcare worker team task queue in step 509 and determines if the tasks are STAT (emergency) tasks in step 513. If it is determined the tasks are emergency tasks the first emergency task is assigned by processor 29 in step 517 to the next ultrasound technician irrespective of equipment or people location data. In step 526 processor 29 checks received input data to determine if the first emergency task is indicated as being complete within a predetermined time period, and if not complete, initiates communication of an alert message to a supervisory worker to escalate task performance. The predetermined time periods vary with task urgency. Specifically, processor 29 checks if an emergency task is complete within a one hour period and a task of a next level of urgency (an ASAP (as soon as possible) task) is complete within a three hour period, for example.

If it is determined the one or more next tasks are not emergency tasks in step 513, processor 29 in step 519 determines if the one or more next tasks are of the next level of urgency (ASAP) tasks. If the one or more next tasks include ASAP tasks, processor 29 selects an ASAP task to be performed nearest worker 503 and adds the task to the worker task list in step 523 and performs step 526 as previously described. If it is determined the one or more next tasks are not ASAP tasks in step 519, processor 29 in step 529 determines if the one or more next tasks include tasks to be performed today. If tasks are to be performed today, processor 29 in step 535 groups tasks by location and assigns a set of tasks grouped by location to a worker. This allocation is subject to change in response to a higher priority emergency or ASAP task requiring performance. If it is determined by processor 29 in step 529 that the one or more next tasks do not include tasks to be performed today, task allocation is complete. Processor 29 adds new tasks in step 555 to prioritized role specific task list 550 and intermittently (e.g., hourly) checks list 550 in step 558 to determine if list 550 has reached the limit of number of tasks in total or of specific urgency level for a day. If the limit is reached, processor 29 initiates communication of an alert message to a supervisory worker indicating the list 550 status. The FIG. 5 process terminates in step 533.

Processor 29 implements task Load Balancing by assigning work, or tasks, to workers, taking into account the amount of work each worker or team is already doing and equipment and people location. Processor 29 applies decision rules a process definition to balance work load between various worker teams so that individual teams have an optimal work load and the overall amount of work is completed in the least amount of time. Workload processor 29 balances workload based on amount of work, as well as nearness of worker, equipment and room to a patient in optimizing processes by assigning work to a team that has the least amount of work, and is closest to the patient, for example. The system reduces time spent on looking for necessary equipment and enables performance of more tasks, in less time, with fewer resources.

Workflow processor 29 accommodates geographic location or nearness of items where it is relevant to a process and determines the patient location, the location of needed workers and/or equipment and calculates the distance between the items. The distance in one embodiment is not just horizontal distance in meters between two items, for example, but also takes into account number of floors, where the stairs or elevators are, and how to get from point A to point B. The mapping of a hospital's physical plant is used to determine these distances, and is therefore employed in the calculations by workflow processor 29. Workflow processor 29 (including a workflow engine) operates in response to a process definition implementing a load balancing function (e.g. using an algorithm), which may be different for each process. Hospitals can modify and adjust a load balancing function by changing a calculation and logic in a process definition. The load balancing function determines who tasks are assigned to, based on the optimal combination of workload (other tasks), task priority (top priority comes first) and nearness.

Tracking processor 25 operates in conjunction with workflow processor 29 to allocate tasks based on location of patient, worker and/or resource, add the location of a patient, worker or resource to process definition conditions and initiate or terminate a process based on location of patient, worker, and/or resource. In operation a process is already active, activated by another event such as patient registration or admission, initiation of an order for treatment or patient discharge. In response to an operational process reaching a step where a task is to be assigned, workflow processor 29 determines which worker to assign the task to. Processor 29 takes into account several factors including the role of the worker (their job function), availability (whether they are currently “on duty”), the workload of this worker (what other tasks are already on this worker's list) and how long will it take the worker to get to a geographic location to perform the task, whether this is the nearest worker of their kind, or is there another worker who can do this task who is closer to the work location. Processor 29 employs a load balancing function (which can be different for each process, and different in each hospital and can be modified by hospitals to optimize their care) to determine who to assign a task to in response to one or more of the factors.

Workflow processor 29 adds the location of a patient, worker and resource to process definition conditions to manage the next step in a process rather than for task allocation. A process may include conditions that deal with the patient location. For example, if a patient is in their room, and no healthcare worker has been in the room for over 2 hours, processor 29 may initiate communication of a message to notify a nurse to check up on the patient. Also if patient vital signs are due (last one taken more than one hour ago), processor 29 initiates communication of a message to alert nursing staff, except if the patient is not in their room. In another example, a patient who arrived at an Emergency Room with a stroke is receiving a CT scan. Tracking processor 25 indicates that the patient is in the CT department and notifies workflow processor 29 of this location and marks the arrival of the patient in the CT department. Processor 29 determines the time it will take for results from the CT scan to be available to a physician to decide on use of thrombolytic therapy for the patient. In a further example, a physician entering a patient room in an Emergency Department (ED) enters data informing processor 29 that a patient was seen by the physician and updates the status of the patient on the ED status board.

Tracking processor 25 in conjunction with workflow processor 29, initiates or terminates a process, based on location of patient, worker and resource. Configuration processor 41 is employed to configure tracking processor 25 and workflow processor 29 to activate (or terminate) a process in response to detected movement of patients, workers and/or resources. The detected movement may be of a particular type (e.g. to a radiology department) or general (e.g., a patient is outside his room). The movement comprises an event monitored by processor 29 which “listens” to these movement events and uses the events to activate a new process, or terminate an active process. Examples of movements that may be used to initiate or terminate a process include, a patient moving from an emergency department to a hospital-wing that is used to terminate an ED monitoring process and initiate an admission process. In another example, a patient arriving in a pre-operation room triggers, or activates, an operating room (OR) management process.

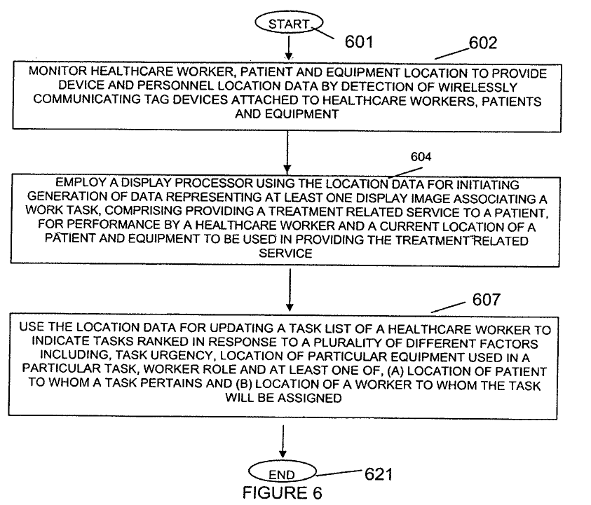

FIG. 6 shows a flowchart of a process performed by personnel and device location sensitive system 10 for managing healthcare worker tasks. In step 602 following the start at step 601, tracking processor 25 (FIG. 1) monitors healthcare worker, patient and equipment location to provide device and personnel location data by detection of wirelessly communicating tag devices attached to healthcare workers, patients and equipment. Display processor 26 in step 604 uses the location data for initiating generation of data representing at least one display image associating a work task, comprising providing a treatment related service to a patient, for performance by a healthcare worker, with a current location of a patient and equipment to be used in providing the treatment related service. Display processor 26 uses the location data for providing a display image associating individual tasks of multiple ranked tasks for one or more different healthcare workers with a current location of a patient and equipment to be used in providing a treatment related service. The individual tasks comprise providing a treatment related service to a patient, for performance by a healthcare worker.

In step 607 workflow processor 29 uses the location data for automatically updating a task list of a healthcare worker to indicate tasks ranked in response to multiple different factors including, task urgency, location of particular equipment used in a particular task, worker role, location of a patient to whom a task pertains and location of a worker to whom the task will be assigned.

In one embodiment workflow processor 29 comprises a workflow engine responsive to a process definition that uses the location data as decision criteria in a workflow process at a point in the process where multiple different next steps are possible, to decide which next step to take in response to the location data. In this embodiment, the workflow engine uses the location data for automatically updating a task list of a healthcare worker to indicate tasks ranked in response to a skill set of the healthcare worker, a current workload of the healthcare worker, urgency of a particular task, a performance location for performance of a particular task and nearness to the performance location of equipment and personnel. The equipment and personnel location comprise a location of particular equipment for use in performing the particular task and a location of the healthcare worker. The workflow engine automatically updates the task list of the healthcare worker in response to, a predetermined worker proficiency level (e.g., worker experience level) in operating the particular equipment used in the particular task and a predetermined worker proficiency level in treating a patient with a particular medical condition. The workflow engine manages a process in response to event associated data comprising data indicating movement of location of, equipment, a patient and a worker and manages a process by initiating a process, terminating a process and moving to a next step in a process. The process of FIG. 6 terminates at step 621.

The systems and processes of FIGS. 1-6 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. System 10 addresses the problems associated with manual location tracking involving asking healthcare workers to manually enter data indicating their own location and/or a patient's location, at regular intervals. This manual tracking is burdensome and vulnerable to users not keep tracking information up to date. The processes and applications may in alternative embodiments, be located on one or more (e.g., distributed) processing devices accessing a network linking the elements of FIG. 1. Further, any of the functions and steps provided in FIGS. 1-6 may be implemented in hardware, software or a combination of both and may reside on one or more processing devices located at any location of a network linking the elements of FIG. 1 or another linked network including the Internet.

What is claimed is:

1. A personnel and device location sensitive system for managing healthcare worker tasks, comprising:
a tracking processor for monitoring healthcare worker, patient and equipment location to provide device and personnel location data by detection of wirelessly communicating tag devices attached to healthcare workers, patients and equipment;
a display processor using said location data for initiating generation of data representing at least one display image associating a work task, comprising providing a treatment related service to a patient, for performance by a healthcare worker, with a current location of a patient and equipment to be used in providing said treatment related service; and
a workflow engine using said location data for updating a task list of a healthcare worker to indicate tasks ranked in response to a plurality of different factors including at least two of, (a) task urgency, (b) location of particular equipment used in a particular task and (c) worker skill level.

2. A system according to claim 1, wherein
said workflow engine uses said location data for updating a task list of a healthcare worker to indicate tasks ranked in response to current workload of said healthcare worker.

3. A system according to claim 1, wherein
said workflow engine uses said location data for updating a task list of a healthcare worker to indicate tasks ranked in response to at least one of, (a) a location of a patient to whom the tasks pertain and (b) a role of said healthcare worker.

4. A system according to claim 1, wherein
said workflow engine uses said location data for updating a task list of a healthcare worker to indicate tasks ranked in response to a location of said healthcare worker.

5. A system according to claim 1, wherein
said workflow engine balances workload of a healthcare worker in response to a process definition.

6. A system according to claim 5, wherein
said workflow engine balances said workload of said healthcare worker in response to current workload and role of said worker and task urgency.

7. A system according to claim 5, wherein
said workflow engine balances said workload of said healthcare worker in response to at least one of, (a) worker and equipment location and (b) worker and patient location.

8. A system according to claim 5, wherein
said workflow engine balances said workload of said healthcare worker in response to location of performance of a task.

9. A system according to claim 1, wherein
said worker skill level includes worker experience level.

10. A system according to claim 1, wherein
said worker skill level includes worker skill level in operating said particular equipment used in said particular task.

11. A system according to claim 1, wherein
said workflow engine updates a task list of a healthcare worker to indicate tasks ranked in response to a location for performance of said particular task and nearness of said location of said particular equipment to said location for performance.

12. A system according to claim 1, wherein
said workflow engine updates a task list of a healthcare worker to indicate tasks ranked in response to a location for performance of said particular task and nearness of said location of a patient and location of a healthcare worker to said location for performance.

13. A personnel and device location sensitive system for managing healthcare worker tasks, comprising:
a tracking processor for monitoring healthcare worker, patient and equipment location to provide device and personnel location data by detection of wirelessly communicating tag devices attached to healthcare workers and equipment; and
a workflow engine, using said location data and responsive to a process definition, for automatically updating a task list of a healthcare worker to indicate tasks ranked in response to a performance location for performance of a particular task and nearness to said performance location of a location of said healthcare worker and,
a skill set of said healthcare worker,
a current workload of said healthcare worker and
urgency of said particular task.

14. A system according to claim 13, wherein
said workflow engine in response to a process definition, automatically updates said task list of said healthcare worker in response to substantially real time location and current workload data.

15. A system according to claim 14, wherein
said workflow engine manages said process by at least one of, (a) initiating a process, (b) terminating a process and (c) moving to a next step in a process.

16. A system according to claim 15, wherein
said workflow engine manages a process in response to event associated data comprising data indicating movement of location of at least one of, (a) equipment, (b) a patient and (c) a worker.

17. A personnel and device location sensitive system for managing healthcare worker tasks, comprising:
a tracking processor for monitoring healthcare worker, patient and equipment location to provide device and personnel location data by detection of wirelessly communicating tag devices attached to healthcare workers and equipment; and
a workflow engine, using said location data and responsive to a process definition, using said location data for automatically updating a task list of a healthcare worker to indicate tasks ranked in response to a performance location for performance of a particular task and nearness to said performance location of,
a location of a patient, and
a location of said healthcare worker.

18. A system according to claim 17, wherein
said workflow engine automatically updates said task list to indicate tasks ranked in response to a location of particular equipment for use in performing said particular task.

19. A system according to claim 17, wherein
said workflow engine automatically updates said task list to indicate tasks ranked in response to a predetermined worker proficiency level in operating said particular equipment used in said particular task.

20. A system according to claim 19, wherein
said worker proficiency level comprises worker experience level.

21. A system according to claim 17, wherein
said workflow engine automatically updates said task list to indicate tasks ranked in response to a predetermined worker proficiency level in treating a patient with a particular medical condition.

22. A system according to claim 17, wherein
said workflow engine automatically updates said task list to indicate tasks ranked in response to task urgency.

23. A personnel and device location sensitive system for managing healthcare worker tasks, comprising:
a tracking processor for monitoring healthcare worker, patient and equipment location to provide device and personnel location data by detection of wirelessly communicating tag devices attached to healthcare workers and equipment; and
a workflow engine responsive to a process definition, for using said location data as decision criteria in a process to select a next step from a plurality of candidate next steps and using said location data for automatically updating a task list of a healthcare worker to indicate tasks ranked in response to a performance location for performance of a particular task and nearness to said performance location of,
a location of particular equipment for use in performing said particular task and
a location said healthcare worker.

24. A personnel and device location sensitive system for managing healthcare worker tasks, comprising
a tracking processor for monitoring healthcare worker, patient and equipment location to provide device and personnel location data by detection of wirelessly communicating tag devices attached to healthcare workers, patients and equipment;
a display processor using said location data for initiating generation of data representing at least one display image associating a work task, comprising providing a treatment related service to a patient, for performance by a healthcare worker, with a current location of a patient and equipment to be used in providing said treatment related service; and
a workflow processor using said location data for updating a task list of a healthcare worker to indicate tasks ranked in response to a plurality of different factors including, task urgency, location of particular equipment used in a particular task, worker role and at least one of, (a) location of patient to whom a task pertains and (b) location of a worker to whom the task will be assigned.

25. A system according to claim 24, wherein
said display processor uses said location data for providing a display image indicating ranked tasks for said healthcare worker.

26. A system according to claim 24, wherein
said display processor uses said location data for providing a display image indicating ranked tasks for a plurality of different healthcare workers.

27. A system according to claim 24, wherein
said display processor uses said location data for providing a display image associating a plurality of ranked tasks, comprising providing a treatment related service to a patient, for performance by a healthcare worker, with a current location of a patient and equipment to be used in providing said treatment related service.

28. A personnel and device location sensitive system for managing healthcare worker tasks, comprising:
a tracking processor for monitoring healthcare worker, patient and equipment location to provide device and personnel location data by detection of wirelessly communicating tag devices attached to healthcare workers and equipment;
a workflow engine using said location data for automatically updating a task list of a healthcare worker to indicate tasks ranked in response to a performance location for performance of a particular task and nearness to said performance location of,
a location of particular equipment for use in performing said particular task,
a location of said healthcare worker and
at least one of, (a) a predetermined worker proficiency level in operating said particular equipment used in said particular task and (b) a predetermined worker proficiency level in treating a patient with a particular medical condition.

29. A system according to claim 28, wherein
said workflow processor automatically updates said task list to indicate tasks ranked in response to, a location of a patient and task urgency.

30. A system according to claim 28, including
a display processor using said location data for initiating generation of data representing at least one display image associating a plurality of ranked tasks, comprising providing a treatment related service to a patient, for performance by a healthcare worker, with a current location of a patient and equipment to be used in providing said treatment related service.

31. A system according to claim 28, wherein
said workflow engine is responsive to a process definition and uses said location data as decision criteria in a workflow process at a point in the process where multiple different next steps are possible to decide which next step to take in response to said location data.
